(19) United States
(12) Patent Application Publication
(10) Pub. No.: US 2010/0127882 A1
(43) Pub. Date: May 27, 2010

(54) Garage Door Closing Confirmation Systems and Methods

(75) Inventor: Nicholas S. Sitarski, Ypsilanti, MI (US)

Correspondence Address: DINSMORE & SHOHL LLP, 1900 CHEMED CENTER, 255 EAST FIFTH STREET, CINCINNATI, OH, 45202, US

(73) Assignee: Toyota Motor Engineering & Manufacturing North America, Inc., Erlanger, KY (US)

(21) Appl. No.: 12/323,064

(22) Filed: Nov. 25, 2008

(51) Int. Cl. G08B 21/00

(52) U.S. Cl. 340/686.1

(57) ABSTRACT

A method for determining the status of a garage door with a garage door opener system comprising a remote control unit and an opener unit includes transmitting a request signal from the remote control unit to the opener unit thereby activating an actuator mechanically coupled to the garage door. After the actuator has been activated, the status of the garage door is determined in response to the request signal received by the opener unit. A confirmation signal indicative of the status of the garage door is then transmitted from the opener unit to the remote control unit. The remote control unit provides an indication to the user indicative of the status of the garage door based on the received confirmation signal, wherein the status of the garage door is one of closed, not closed or unknown.

### TECHNICAL FIELD

The present invention generally relates to openers for garage doors and, more specifically, to systems and methods for obtaining garage door closure confirmation.

### BACKGROUND

Garage doors are often equipped with systems which permit the garage door to be opened and closed remotely, such as from within a vehicle or a building. Such systems generally comprise a remote control unit and an opener operatively coupled to the garage door. The remote control unit may utilize radio frequency (RF) signals to actuate the opener and thereby open or close the garage door. For example, when the remote control unit is located in a vehicle, a user exiting the garage in the vehicle may utilize the remote control unit from the vehicle to activate the opener thereby closing the garage door from within the vehicle to close the garage door.

Generally, a user is able to visually confirm whether the garage door has closed before leaving the vicinity of the garage door. However, under certain circumstances, visual confirmation of the garage door status (e.g., open or closed) may not be obtainable. For example, visual confirmation of the garage door status may be difficult to obtain where a driveway curves away from the garage door or where obstructions visually impede a direct line of sight to the garage door. Similarly, a user may not be able to visually ascertain the status of the garage door for a side-entry garage. In still other circumstances, visual confirmation of the status of the garage door may not be feasible, such as when a garage door opens directly onto a busy street and a user may be unable to both monitor traffic as well as the status of the garage.

Accordingly, a need exists for alternative systems and methods for use in conjunction with garage door openers for obtaining garage door status information confirmation.

### SUMMARY

In one embodiment, a method for determining the status of a garage door with a garage door opener system comprising a remote control unit and an opener unit includes transmitting a request signal from the remote control unit to the opener unit thereby activating an actuator mechanically coupled to the garage door. After the actuator has been activated, the status of the garage door is determined in response to the request signal received by the opener unit. A confirmation signal indicative of the status of the garage door is then transmitted from the opener unit to the remote control unit. The remote control unit provides an indication to the user indicative of the status of the garage door based on the received confirmation signal, wherein the status of the garage door is one of closed, not closed or unknown.

In another embodiment, a garage door opener system for indicating a status of a garage door to a user includes a remote control unit and an opener unit. The opener unit is operable may be operable to receive a request signal from the remote control unit. After the opener unit receives the request signal, the opener unit may be operable to activate an actuator coupled to the garage door when the request signal is received from the remote control unit thereby opening or closing the garage door. After the actuator has been activated, the opener unit determines the status of the garage door (e.g., closed, not closed or indeterminate). The opener unit is also operable to transmit a confirmation signal to the remote control unit indicative of the status of the garage door in response to the request signal and after the actuator has been activated. The remote control unit may be operable to transmit a request signal to the opener unit as well as receive a confirmation signal from the opener unit. When the remote control unit receives a confirmation signal from the opener unit, the opener unit may provide an indication to a user of the remote control unit indicative of the status of the garage door based on the received confirmation signal.

In yet another embodiment, a vehicle includes a remote control unit for determining a status of a garage door mechanically coupled to a garage door opener unit. The remote control unit includes an input device, a warning indicator, a transceiver and a programmable logic controller. The input device may be electrically coupled to the programmable logic controller and is operable to provide user input into the remote control unit. The transceiver may be electrically coupled to the programmable logic controller and may be operable to transmit request signals from the programmable logic controller to the opener unit and receive confirmation signals indicative of the status of the garage door from the opener unit and relay the confirmation signals to the programmable logic controller, wherein the status of the garage door is closed, not closed or unknown. The warning indicator may be electrically coupled to the programmable logic controller and may be operable to provide an indication of the status of the garage door when the remote control unit receives the confirmation signal from the opener unit. The programmable logic controller may be operable to cause the warning indicator to provide an indication of the status of the garage door based on confirmation signals received from the opener unit through the transceiver and cause the transceiver to transmit request signals to the opener unit based on input received from the input device, thereby causing the opener unit to open or close the garage door.

These and additional features provided by the embodiments of the present invention will be more fully understood in view of the following detailed description, in conjunction with the drawings.

### BRIEF DESCRIPTION OF THE DRAWINGS

The embodiments set forth in the drawings are illustrative and exemplary in nature and not intended to limit the inventions defined by the claims. The following detailed description of the illustrative embodiments can be understood when read in conjunction with the following drawings, where like structure is indicated with like reference numerals and in which:

FIG. 1 depicts a block diagram of a garage door opener system for providing the status of a garage door according to one or more embodiments shown and described herein; and

FIG. 2 depicts a flow diagram of a method of obtaining the status of a garage door according to one or more embodiments shown and described herein.

### DETAILED DESCRIPTION

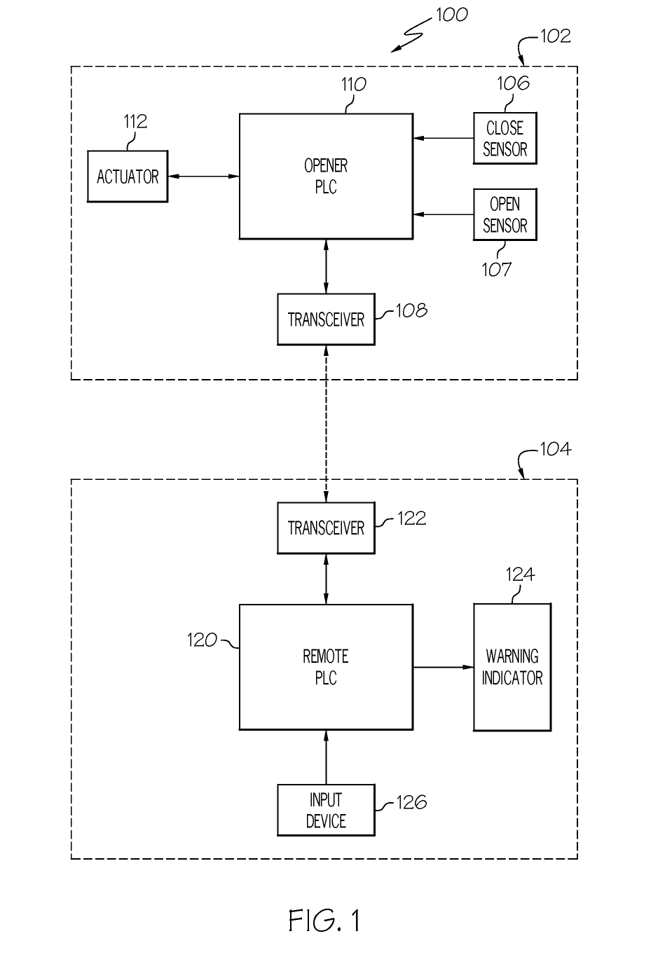

FIG. 1 generally depicts one embodiment of a garage door opener system which may be utilized to obtain the status (e.g., open, closed or unknown) of a garage door. The garage door opener system generally comprises an opener and a remote control unit. The opener may comprise an actuator, a programmable control unit, a sensor and a transceiver. The remote control unit may generally comprise a programmable control unit, an input device, a warning indicator and a transceiver. Each of these components and their interconnectivity will be described in more detail below. Further, it should be understood that, while the solid arrows shown in FIG. 1 generally indicate the interconnectivity between various component parts of the garage door opener system, it should also be understood that these arrows are also indicative of electrical signals passed between the various component parts of the system. Further, it should also be understood that the dashed arrows shown in FIG. 1 are indicative of an electromagnetic signal propagated between various components of the system. In addition to the components of the garage door opener system, the operation of the garage door opener system and methods of determining the status of a garage door will also be described in further detail herein.

Referring now to FIG. 1, a garage door opener system 100 is shown according to one embodiment shown and described herein. The garage door opener system 100 may generally comprise an opener unit 102 and a remote control unit 104. The opener unit 102 generally comprises an actuator 112 which may be attached to a garage door (not shown) or a gate (not shown). When attached to a garage door or gate, the actuator 112 is operable to impart movement to the garage door or gate thereby opening and/or closing the garage door or gate. For example, when the garage door opener system 100 is used in conjunction with a typical garage door (e.g., a garage door which may be vertically raised or lowered to facilitate opening and closing the garage door), the actuator 112 may be an electric motor (not shown) having a rotating armature. The garage door may be mechanically coupled to a carriage which may be slidably positioned on a track coupled to the garage door opener system 100. A belt or chain (not shown) mechanically couples the carriage to the armature of the electric motor. When the garage door opener system 100 is activated, the armature of the electric motor is rotated which, in turn, causes the carriage to be displaced along the track, thereby raising or lowering the garage door depending on the direction of rotation of the armature.

To facilitate control of the actuator 112, the opener unit 102 may also comprise an opener programmable logic controller (PLC) 110 electrically coupled to the actuator 112. In one embodiment, the opener PLC 110 supplies control signals to the actuator 112 which switch the actuator 112 on or off and control the direction of motion of the actuator 112. For example, when the actuator 112 is an electric motor, as discussed above, the opener PLC 110 is operable to switch the electric motor on and off and control the direction of rotation of the armature of the electric motor.

The opener unit 102 may also comprise a transceiver, such as the opener radio frequency (RF) transceiver 108. The opener RF transceiver 108 is operable to receive radio frequency signals from the remote control unit 104 and send radio frequency signals to the remote control unit 104, as will be discussed in more detail herein. The opener RF transceiver 108 is electrically coupled to the opener PLC 110 such that RF signals received by the opener RF transceiver 108 from the remote control unit 104 may be converted by the opener RF transceiver 108 to electrical signals and passed to the opener PLC 110. Similarly, the opener RF transceiver 108 may receive electrical signals from the opener PLC 110 and convert the electrical signals to RF signals which are transmitted by the opener RF transceiver 108 to the remote control unit 104.

The opener unit 102 may also comprise a close sensor 106 electrically coupled to the PLC 110. In one embodiment, as shown in FIG. 1, the close sensor 106 is a photo sensor positioned proximate the garage door. The close sensor 106 may be positioned relative to the garage door such that the close sensor 106 is operable to detect whether the garage door is open or closed. For example, when the garage door is closed, the close sensor 106 may provide an electrical signal to the opener PLC 110 indicating that the garage door is closed. Similarly, when the garage door is open, the close sensor 106 may provide an electrical signal (or no signal at all) to the opener PLC 110 thereby indicating that the garage door is open.

In another embodiment, the opener unit 102 may additionally comprise a second sensor. The second sensor may be an open sensor 107 electrically coupled to the opener PLC 110. Both the close sensor 106 and the open second sensor 107 may comprise photo detectors as described hereinabove. In this embodiment, close sensor 106 may be positioned proximate the garage door such that sensor 106 provides a signal to the opener PLC 110 when the garage door is closed. The open sensor 107 may be positioned proximate the garage door such that the second sensor provides a signal to the opener PLC 110 when the garage door is open. Accordingly, when the garage door is open, the open sensor 107 provides a signal to the opener PLC 110 and the close sensor 106 does not provide a signal to the opener PLC 110 thus indicating that the garage door is open. Similarly, when the garage door is closed, close sensor 106 provides a signal to the opener PLC 110 and the open sensor 107 does not provide a signal to the opener PLC 110 thus indicating that the garage door is closed. When neither the close sensor 106 nor open sensor 107 provides a signal to the opener PLC 110 thus indicating that the garage door is in an indeterminate state (e.g., neither open nor closed). Accordingly, when the opener unit 102 comprises multiple sensors, it may be possible to determine when a garage door coupled to the unit is opened, closed or at an indeterminate state (e.g., neither open nor closed).

Alternatively or additionally, the opener unit 102 may comprise one or more sensors operatively coupled to the actuator 112 and operable to determine if the garage door coupled to the opener unit 102 is open or closed based on the status of the actuator 112. For example, when the actuator 112 is an electric motor coupled to the garage door with a chain or belt, the electric motor may comprise a shaft encoder or similar sensor operatively coupled to the armature of the motor and electrically coupled to the opener PLC 110. The shaft encoder may be operable to provide a signal to the opener PLC 110 indicating whether the garage door is open, closed or at an intermediate state based on the rotation of the armature. In this embodiment, the shaft encoder may perform the function of both the close sensor 106 and the open sensor 107.

While specific reference has been made herein to the sensors 106, 107 comprising photo detectors, it should be understood that sensors 106, 107 may comprise any sensor suitable for detecting the position of an object including, without limitation, mechanical limit switches, inductive sensors, piezo-electric sensors, magnetic field sensors and the like. Accordingly, it should be understood that the sensors 106, 107 may be optical sensors, mechanical sensors, electro-mechanical sensors, electro-magnetic sensors, and the like.

Still referring to FIG. 1, the remote control unit 104 of the garage door opener system 100 may comprise a programmable logic controller such as the remote programmable logic controller (PLC) 120. The remote PLC 120 may be electrically coupled to a transceiver, such as the remote radio frequency (RF) transceiver 122. The remote RF transceiver 122 is operable to receive radio frequency signals from the opener unit 102 and send radio frequency signals to the opener unit 102, as will be discussed in more detail herein. RF signals received by the remote RF transceiver 122 from the opener unit 102 may be converted by the remote RF transceiver 122 to electrical signals and passed to the remote PLC 120. Similarly, the remote RF transceiver 122 may receive electrical signals from the remote PLC 120 and convert the electrical signals to RF signals which are transmitted by the remote RF transceiver 122 to the opener unit 102.

The remote control unit 104 may also comprise an input device 126 electrically coupled to the remote PLC 120. In one embodiment, the input device 126 comprises a push button electrically coupled to the remote PLC 120. When the push button is actuated, an electrical signal may be sent to the remote PLC 120. In another embodiment, the input device 126 may comprise a microphone electrically coupled to the remote PLC 120. In this embodiment, the PLC 120 may be programmed with voice recognition software such that input received from the microphone may be used to cause the remote PLC 120 to execute one or more computer executable instruction sets contained on the remote PLC 120.

While specific reference has been made herein to the input device 126 comprising a push button or a microphone, it should be understood that the input device 126 may comprise any input device suitable for providing an electrical signal to a programmable logic controller. Accordingly, it should be understood that the input device 126 may comprise various switches, detectors, piezo-electric devices, touch screens and the like. Moreover, it should also be understood that the remote control unit 104 may comprise a plurality of input devices and each input device may be electrically coupled to the remote PLC 120.

The remote control unit 104 may also comprise a warning indicator 124 electrically coupled to the remote PLC 120. In one embodiment, the warning indicator 124 may comprise a visual indicator, such as one or more LED lights. For example, where the warning indicator 124 comprises a single LED light, the LED light may be operable to illuminate in several different colors (e.g., green, yellow and red) thereby providing different visual indicators to a user. Similarly, where the warning indicator 124 comprises multiple LED lights, each LED may illuminate in a different color (e.g., green, yellow, red) thereby providing various visual indicators to a user. Alternatively, the warning indicator 124 may comprise an active display operable to display text and/or graphics to a user. The text and/or graphics may be indicative of the status of the garage door (e.g., open, closed, indeterminate or unknown).

In another embodiment, the warning indicator 124 may comprise an audible indicator, such as a beeper, buzzer, speaker or the like. Where the audible indicator is a speaker, the remote PLC 120 may be operable to play one or more pre-configured audio files through the speaker. In yet another embodiment, the warning indicator 124 comprises both a visual indicator and an audible indicator.

In one embodiment, the remote control unit 104 of the garage door opener system 100 may be a portable, self-contained unit. In another embodiment, the remote control unit 104 of the garage door opener system 100 is integrated into the interior of a vehicle. For example, the remote control unit 104 may be integrated into an instrument panel located on the dashboard of the vehicle, in a sun visor, or in the bezel surrounding the rear-view mirror.

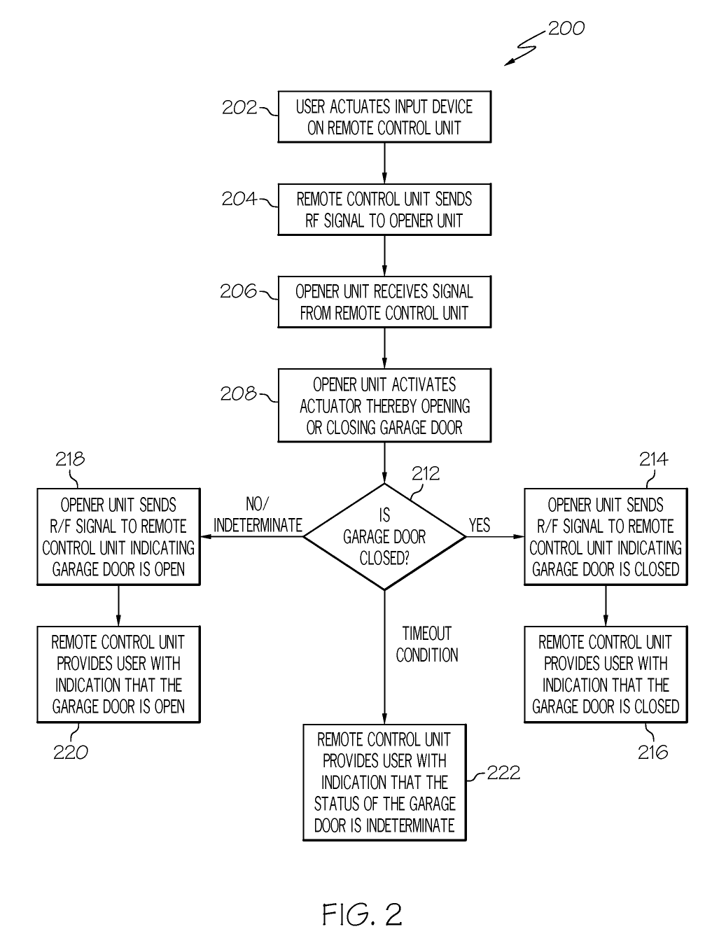

The operation of the garage door opener system 100 and methods for using the garage door opener system 100 will now be described with specific reference to FIGS. 1 and 2.

FIG. 2 depicts a flow diagram of one embodiment of a method 200 for determining the status of a garage door. According to one embodiment described herein, the status of the garage door may be either closed or open (e.g., not closed). In another embodiment, the status of the garage door may be closed, not open (e.g., not closed) or indeterminate. Each embodiment will be described with respect to the garage door opener system depicted in FIG. 1 and the flow diagram of FIG. 2.

The method 200 of determining the status of a garage door begins at step 202 when a user actuates the input device 126 of the remote control unit 104 of the garage door opener system 100 thereby generating a request to either open or close the garage door coupled to the opener unit 102 of the garage door opener system 100. For example, when the input device 126 is a push button, the input device 126 may be actuated when the user presses and releases the push button. Alternatively, when the input device 126 is voice actuated, such as when the input device 126 is a microphone coupled to the remote PLC unit 120, the input device 126 may be actuated by an audible command verbalized by the user and recognized by the remote control unit 104 with voice command recognition software installed in the remote PLC 120.

In a next step 204, actuation of the input device 126 causes the remote PLC 120 to generate an open or close request to the opener unit 110. More specifically, the remote PLC 120 is programmed such that, when the input device 126 is actuated, the remote PLC 120 generates an open or close request in the form of an electrical signal. The electrical signal is passed from the remote PLC 120 to the remote RF transceiver 122 which converts and transmits the electrical signal as an RF signal (the “RF request signal”). After the remote control unit 104 transmits the RF request signal to the opener unit 102, the remote control unit 104 enters a stand-by mode and waits for an RF confirmation signal from the opener unit 102. In one embodiment, the stand-by mode is timed such that, if the remote control unit 104 does not receive a confirmation signal from the opener unit 102 within a specified time interval, the remote PLC 120 exits the stand-by mode and sets the status of the garage door as indeterminate or unknown, as will be discussed further herein.

In a next step 206, when the remote control unit 102 is in range of opener unit 104, the opener unit 102 and, more specifically, the opener RF transceiver 108 of the opener unit 102, receives the RF request signal transmitted from the remote control unit 104. The RF transceiver 108 converts the received RF request signal to an electrical signal which is relayed to the opener PLC 110.

In a next step 208, upon receiving the converted RF request signal, the opener PLC 110 may be programmed to send an electrical control signal to the actuator 112. The electrical control signal sent to the actuator 112 may be operable to stop the actuator (such as when the actuator is in the process of opening or closing the attached garage door), cause the actuator to open the garage door, or cause the actuator to close the garage door.

In one embodiment, after receiving an electrical control signal from the opener PLC 110, the actuator 112 may be operable to provide the opener PLC 110 with an actuator stop signal. For example, when the electrical control signal from the opener PLC 110 causes the actuator 112 to stop, the actuator 112 may provide the opener PLC 120 with an actuator stop signal indicating that the actuator has stopped. Similarly, when the electrical control signal from the opener PLC 110 causes the actuator to open or close the garage door, the actuator 112 may provide the PLC 110 with an actuator stop signal once the opening or closing operation has been completed (e.g., when the actuator 112 has stopped).

In a next step 212, after receiving the actuator stop signal from the actuator 112, the opener PLC 110 ascertains the status of the garage door based on signal(s) received (or not received) by the sensor 106 or sensors 106, 107 electrically coupled to the opener PLC 110. For example, in one embodiment, where the opener unit 102 comprises a single sensor 106 operable to relay a signal to the opener PLC 110 when the garage door is closed, the opener PLC 110 determines if the sensor 106 has provided a signal indicating that the garage door is closed. If the sensor 106 has provided a signal indicating that the garage door is closed, the opener PLC 110 sets the status of the garage door as “closed.” If the sensor 106 has not provided a signal to the opener PLC 110 indicating the garage door is closed, the opener PLC 110 sets the garage door status as “indeterminate” or “unknown” (e.g., the garage door may be fully or partially open).

In another embodiment, when the opener unit 102 comprises multiple sensors 106, 107, the opener PLC 110 determines the status of the garage door based on signals received (or not received) from both sensors 106. For example, when the close sensor 106 provides a signal to the opener PLC 110 indicating that the garage door is closed, and the open sensor 107 has not provided a signal to the opener PLC 110 (or, alternatively, provided a signal to the opener PLC 110 that the garage door is not open), the opener PLC 110 sets the status of the garage door as “closed.” Similarly, when the open sensor 107 provides a signal to the opener PLC 110 indicating that the garage door is open, and the closed sensor 106 has not provided a signal to the opener PLC 110 (or, alternatively, provided a signal to the opener PLC 110 that the garage door is not closed), the opener PLC 110 sets the status of the garage door as “open.” When neither the open sensor 107 nor the closed sensor 106 has provided the opener PLC 110 with a signal (or, alternatively, when the open sensor 107 has provided a signal indicating that the garage door is not open and the closed sensor has provided a signal indicating that the garage door is not closed), the opener PLC 110 sets the status of the garage door as “indeterminate” or “unknown.”

When the status of the garage door is closed, the opener unit 102 transmits an RF confirmation signal to the remote control unit indicating that the garage door is closed in step 214. More specifically, after the opener PLC has set the status of the garage door to “closed,” the opener PLC 110 sends an electrical signal to the opener RF transceiver 108 indicating that the garage door is closed. This electrical signal is converted by the RF transceiver to an RF confirmation signal, specifically an RF closed confirmation signal, which is transmitted to the remote control unit 104.

In step 216 the remote control unit 104, specifically the remote RF receiver 122, receives the RF closed confirmation signal and coverts the RF closed confirmation signal to a closed confirmation electrical signal which is passed to the remote PLC 120. When the remote control unit 104 receives the RF closed confirmation signal from the opener unit 102, the remote control unit 104 exits the stand-by mode and processes the RF closed confirmation signal. Upon receiving the closed confirmation electrical signal, the remote PLC 120 may be programmed to provide a user with a visual and/or audible indication that the garage door is closed via the warning indicator 124. For example, in one embodiment, when the warning indicator 124 comprises one LED that is capable of being illuminated in different colors, the remote PLC 120 may cause the LED to be illuminate as green when the garage door is closed. In another embodiment, when the warning indicator 124 comprises multiple LEDs of different colors, the remote PLC 120 may be programmed to illuminate a green LED thereby indicating to the user that the garage door is closed.

In yet another embodiment, when the warning indicator is an audible indicator, the remote PLC 120 may be programmed to cause the audible indicator to play a specific tone or message thereby indicating to the user that the garage is closed. In yet another embodiment, when the warning indicator is operable to provide both a visual and audible indicator, the remote PLC may be programmed to activate both the visual and audible indicators to provide both visual and audible indications to the user that the garage door is closed.

Alternatively, when the opener PLC 110 has set the status of the garage door to “open” or “indeterminate,” the opener unit 102 transmits an RF confirmation signal to the remote control unit indicating that the garage door is open (e.g., not closed) in step 218. More specifically, after the opener PLC has set the status of the garage door to “open” or “indeterminate, “the opener PLC 110 sends an electrical signal to the opener RF transceiver 108 indicating that the garage door is not closed. This electrical signal is converted by the RF transceiver to an RF confirmation signal, specifically an RF open confirmation signal, which is transmitted to the remote control unit 104.

In step 220 the remote control unit 104, specifically the remote RF receiver 122, receives the RF open confirmation signal and coverts the RF open confirmation signal to a open confirmation electrical signal which is passed to the remote PLC 120. When the remote control unit 104 receives the RF open confirmation signal from the opener unit 102, the remote control unit 104 exits the stand-by mode and processes the RF open confirmation signal. Upon receiving the open confirmation electrical signal, the remote PLC 120 may be programmed to provide a user with a visual and/or audible indication that the garage door is open via the warning indicator 124. For example, in one embodiment, when the warning indicator 124 comprises one LED that is capable of being illuminated in different colors, the remote PLC 120 may cause the LED to be illuminate as red when the garage door is open thereby indicating to the user that the garage door is open. In another embodiment, when the warning indicator 124 comprises multiple LEDs of different colors, the remote PLC 120 may be programmed to illuminate a red LED thereby indicating to the user that the garage door is open.

In yet another embodiment, when the warning indicator is an audible indicator, the remote PLC 120 may be programmed to cause the audible indicator to play a specific tone or message thereby indicating to the user that the garage is open. In yet another embodiment, when the warning indicator is operable to provide both a visual and audible indicator, the remote PLC may be programmed to activate both the visual and audible indicators to provide both visual and audible indications to the user that the garage door is open.

As discussed hereinabove with respect to step 204, the remote control unit 104 may enter a stand-by mode after transmitting the RF request signal to the opener unit. If the remote control unit 104 does not receive an RF confirmation signal from the opener unit within a predetermined time period (such as when the remote control unit 104 is out of range of the opener unit 102, the opener unit 102 fails to send an RF confirmation signal, etc.), the remote control unit 104 may exit the stand-by mode in step 222. Under these conditions, the remote PLC 120 is programmed to set the status of the garage door as unknown and provide the user with an indication that the status of the garage door is unknown via the warning indicator 124. For example, in one embodiment, when the warning indicator 124 comprises one LED that is capable of being illuminated in different colors, the remote PLC 120 may cause the LED to be illuminate as yellow when the status of the garage door is unknown thereby indicating to the user that the status of the garage door is unknown. In another embodiment, when the warning indicator 124 comprises multiple LEDs of different colors, the remote PLC 120 may be programmed to illuminate a yellow LED thereby indicating to the user that the status of the garage door is unknown.

In yet another embodiment, when the warning indicator is an audible indicator, the remote PLC 120 may be programmed to cause the audible indicator to play a specific tone or message thereby indicating to the user that the status of the garage is unknown. In yet another embodiment, when the warning indicator is operable to provide both a visual and audible indicator, the remote PLC may be programmed to activate both the visual and audible indicators to provide both visual and audible indications to the user that the status of the garage door is unknown.

Accordingly, it should now be understood that the garage door opener system 100 and method 200 for confirming the status of a garage door described may be used to provide a user with visual and/or audible indications as to the status (e.g., open, closed or unknown) of a garage door mechanically coupled to the garage door opener system 100. It should also be understood that, as described herein, the garage door opener system 100 and, more specifically, the opener unit 102 of the garage door opener system 100 sends RF confirmation signals related to the status of the garage door only after an RF request signal has been received from the remote control unit 104 and the actuator 112 has been activated and brought to a stop. In this manner, the status of the garage door is relayed to the remote control unit only after a requested operation (e.g., open garage door, close garage door, stop garage door between open and closed) has been performed.

Further, it should also be understood that, while specific reference has been made herein to using the garage door opener system 100 and method 200 to confirm the status of a typical garage door, such as a garage door that is lowered and raised vertically, the garage door opener system 100 and method 200 may also be used in conjunction with garage doors and/or gates of various other configurations, such as garage doors or gates that open and close horizontally or garage doors or gates that pivot about a vertical axis.

While particular embodiments and aspects of the present invention have been illustrated and described herein, various other changes and modifications can be made without departing from the spirit and scope of the invention. Moreover, although various inventive aspects have been described herein, such aspects need not be utilized in combination. It is therefore intended that the appended claims cover all such changes and modifications that are within the scope of this invention.

What is claimed is:

1. A method for determining the status of a garage door with a garage door opener system mechanically coupled to the garage door, wherein the garage door opener system comprises an opener unit and a remote control unit, the method comprising:
transmitting a request signal from the remote control unit to the opener unit;
activating an actuator mechanically coupled to the garage door after the request signal is received by the opener unit;
determining a status of the garage door in response to the request signal after the actuator has been activated, wherein the status of the garage door is closed, not closed or unknown;
transmitting a confirmation signal indicative of the status of the garage door from the opener unit to the remote control unit; and
providing an indication of the status of the garage door to a user based on the received confirmation signal.

2. The method of claim 1 wherein the indication provided to the user is an audible indication, a visual indication or both.

3. The method of claim 2 wherein the indication provided to the user is a visual indication in which different LEDs are illuminated to represent the status of the garage door.

4. The method of claim 2 wherein the indication provided to the user is a visual indication in which a single LED is illuminated in different colors with each color representing a different status of the garage door.

5. The method of claim 1 wherein the status of the garage door is determined by sensing if the garage door is closed.

6. The method of claim 1 wherein the status of the garage door is determined by sensing if the garage door is closed and sensing if the garage door is open.

7. The method of claim 6 wherein, when the garage door is neither open nor closed the status of the garage door is unknown.

8. The method of claim 1 wherein, when the status of the garage door is anything other than closed, the confirmation signal transmitted by the opener unit is indicative of the status of the garage door being not closed.

9. A garage door opener system for indicating a status of a garage door to a user, the garage door opener system comprising a remote control unit and an opener unit, wherein:
the opener unit is operable to:
receive a request signal from the remote control unit;
activate an actuator coupled to the garage door when the request signal is received from the remote control unit thereby opening or closing the garage door;
determine a status of the garage door after the actuator has been activated, wherein the status is closed, not closed or unknown; and
transmit a confirmation signal to the remote control unit indicative of the status of the garage door in response to the request signal after the actuator has been activated; and
the remote control unit is operable to:
transmit a request signal to the opener unit;
receive a confirmation signal from the opener unit; and
provide an indication of the status of the garage door to a user based on the received confirmation signal.

10. The system of claim 9 wherein the opener unit comprises an opener programmable logic controller, a close sensor, an opener transceiver and the actuator, wherein:
the actuator is electrically coupled to the opener programmable logic controller and operable to be mechanically coupled to a garage door;
the opener transceiver is electrically coupled to the opener programmable logic controller, wherein the opener transceiver is operable to receive the request signal from the opener remote control unit and relay the request signal to the opener programmable logic controller and transmit the confirmation signal from the opener programmable logic controller to the remote control unit;
the close sensor is electrically coupled to the opener programmable logic controller and is operable to transmit a signal to the opener programmable logic controller indicative of whether the garage door is closed; and
the opener programmable logic controller is operable to activate the actuator based on request signals received from the remote control unit through the opener transceiver, determine the status of the garage door based on signals received from the close sensor and cause the opener transceiver to transmit confirmation signals indicative of the status of the garage door to the remote control unit.

11. The system of claim 10 wherein the opener unit further comprises an open sensor electrically coupled to the opener programmable logic controller, wherein the open sensor is operable to transmit a signal to the opener programmable logic controller indicative of the garage door being open; and
the opener programmable logic controller is further operable to determine the status of the garage door based on signals received from the open sensor.

12. The system of claim 9 wherein the remote control unit comprises a remote programmable logic controller, an input device, a remote transceiver and a warning indicator, wherein:
the input device is electrically coupled to the remote programmable logic controller and is operable to provide user input into the remote control unit;
the remote transceiver is electrically coupled to the remote programmable logic controller and is operable to transmit request signals from the remote programmable logic controller to the opener unit and receive confirmation signals from the opener unit and relay the confirmation signals to the remote programmable logic controller;
the warning indicator is electrically coupled to the remote programmable logic controller and is operable to provide an indication of the status of the garage door when the remote control unit receives the confirmation signal from the opener unit; and
the remote programmable logic controller is operable to cause the warning indicator to provide an indication of the status of the garage door based on confirmation signals received from the opener unit through the remote transceiver and cause the remote transceiver to transmit request signals to the opener unit based on input received from the input device.

13. The system of claim 12 wherein the warning indicator comprises an audible warning indicator, a visual warning indicator or both.

14. The system of claim 12 wherein the warning indicator comprises a plurality of LEDs with each LED being indicative of a different garage door status such that, when the LED is illuminated, the status of the garage door associated with the LED is visually conveyed to a user.

15. The system of claim 12 wherein the warning indicator comprises a single LED which is illuminated in different colors wherein each color corresponds to a different status of the garage door.

16. A vehicle comprising a remote control unit for determining a status of a garage door mechanically coupled to a garage door opener unit, the remote control unit comprising an input device, a warning indicator, a transceiver and a programmable logic controller, wherein:
the input device is electrically coupled to the programmable logic controller and is operable to provide user input into the remote control unit;
the transceiver is electrically coupled to the programmable logic controller and is operable to transmit request signals from the programmable logic controller to the opener unit and receive confirmation signals indicative of the status of the garage door from the opener unit and relay the confirmation signals to the programmable logic controller, wherein the status of the garage door is closed, not closed or unknown;
the warning indicator is electrically coupled to the programmable logic controller and is operable to provide an indication of the status of the garage door when the remote control unit receives the confirmation signal from the opener unit; and
the programmable logic controller is operable to cause the warning indicator to provide an indication of the status of the garage door based on confirmation signals received from the opener unit through the transceiver and cause the transceiver to transmit request signals to the opener unit based on input received from the input device, thereby causing the opener unit to open or close the garage door.

17. The vehicle of claim 16 wherein the warning indicator comprises a visual indicator, an audible indicator or both.

18. The vehicle of claim 16 wherein:
the warning indicator comprises at least one visual indicator; and
when the status of the garage door is closed, the visual indicator is illuminated green, when the status of the garage door is not closed, the visual indicator is illuminated red and, when the status of the garage door is unknown, the visual indicator is illuminated yellow.

19. The vehicle of claim 16 wherein the remote control unit is operable to enter a stand-by mode after transmitting a request signal to the opener unit and the remote control unit remains in the stand-by mode until a confirmation signal is received by the remote control unit from the opener or until a predetermined time period expires, wherein, when the predetermined time period expires and no confirmation signal has been received from the opener unit, the remote control unit is operable to provide an indication that the status of the garage door is unknown.

20. The vehicle of claim 16 wherein the remote control unit is integral with a bezel surrounding a rear view mirror.
